(19) United States
(12) Patent Application Publication
(10) Pub. No.: US 2024/0147964 A1
(43) Pub. Date: May 9, 2024

(54) APPARATUS FOR A PET TREAT HOLDER

(71) Applicant: P&P IMPORTS LLC, Irvine, CA (US)

(72) Inventors: Peter Tanoury, Newport Beach, CA (US); Willis Santamaria, Diamond Bar, CA (US)

(73) Assignee: P&P IMPORTS LLC, Irvine, CA (US)

(21) Appl. No.: 17/981,018

(22) Filed: Nov. 4, 2022

(51) Int. Cl. A01K 15/02

(52) U.S. Cl. CPC A01K 15/026

(57) ABSTRACT

The present disclosure relates to an apparatus and system for providing a pet treat holder apparatus. The pet treat holder apparatus includes a housing portion. The housing portion includes a first coupling means and an opening. The opening includes a first width being less than a second width thereby forming a tapered surface. The pet treat holder apparatus includes a shaft portion having a retaining facet and a second coupling means. The shaft portion and the housing portion are axially coupled. The shaft portion and the housing portion are configured to securely retain a pet treat between the tapered surface of the housing portion and the retaining facet of the shaft portion.

### FIELD OF THE DISCLOSURE

The embodiments disclosed herein relate to an apparatus for a pet treat holder.

### BACKGROUND

Apparatus relating to pet treat holders are known. Apparatus for pet treat holders that increase safety during consumption of pet treats are also known. Yet known apparatus for pet treat holders are difficult to set up having intricate parts, hard to keep sterile, and do not provide an entertaining and enticing platform for pets. For Example, United States Pre-Grant Publication 2009/0217885 discloses a prior art pet treat holder including a gripping feature and a slot for inserting a pet treat. However, the slot that retains the pet treat is inaccessible for cleaning by hand, which promotes bacteria growth. Moreover, in order to access the recessed portion of prior art pet treat holders, large portions of the holder must be manually deformed, which is also not conducive for efficient sterilization, thus reducing user friendliness.

FIGS. 1A-1B show exemplary prior art pet treat holders 100A, 100B. Some of these pet treat holders utilize a gripping feature for securing pet treats inside a housing, for example, holder 100B. Yet these types of gripping features having textured surfaces retain food particles and are difficult to access for cleaning, thereby creating unsanitary conditions and promoting bacteria growth. For example, the textured surfaces inside FIG. 1B are prone for allowing building up of food particles, which harden inside the thin, inaccessible crevasses of the gripping features. These and other known pet treat holders are therefore difficult to access for thorough cleaning, and create conditions that promote excess bacteria growth, unpleasant smells, and the potential for staining furniture and carpets.

### SUMMARY

The present disclosure relates to an apparatus for providing a pet treat holder apparatus. The pet treat holder apparatus includes a housing portion. The housing portion includes a first coupling means and an opening. The opening includes a first width being less than a second width thereby forming a tapered surface. The pet treat holder apparatus includes a shaft portion having a retaining facet and a second coupling means. The shaft portion and the housing portion are axially coupled. The shaft portion and the housing portion are configured to securely retain a pet treat via the tapered surface of the housing portion and the retaining facet of the shaft portion.

One or more embodiments described herein relate to a pet treat holder apparatus having a body portion having a first distal end handle and a housing portion having a second distal end handle. In some embodiments, the body portion and the housing portion are configured to be removably coupled via a threaded male/female coupling. In some embodiments, an actuator for the threaded male/female coupling corresponds to the first distal end handle or the second distal end handle.

One or more embodiment described herein relate to pet treat holder apparatus including a body portion having a first distal end handle and a housing portion having a second distal end handle. In some embodiments, the body portion and the housing portion are configured to be removably coupled via a turnkey handle coupling. In some embodiments, the turnkey handle coupling is recessed into the first distal end handle or the second distal end handle. In some embodiments, first distal end handle or the second distal end handle correspond to a shape of a polygon. In some embodiments, the shape of the polygon corresponds to a conical shape.

### BRIEF DESCRIPTION OF THE DRAWINGS

FIG. 1A-1B are exemplary illustration of the prior art;

FIGS. 2A-2E illustrate a schematic view of a pet treat holder apparatus in accordance with one or more embodiments;

FIGS. 3A-3B illustrate a schematic cut-out view of the pet treat holder apparatus shown in FIG. 2;

FIG. 4A-4E illustrate an enlarged view of the pet treat holder apparats shaft shown in FIG. 2B, in accordance with one or more embodiments;

FIGS. 5A-5C illustrate one or more embodiments of the pet treat holder apparatus of FIG. 1;

FIG. 6 is a schematic view of a pet treat holder apparatus in accordance with one or more embodiments; and

FIGS. 7A-7D are schematic views of a pet treat holder apparatus in accordance with one or more embodiments.

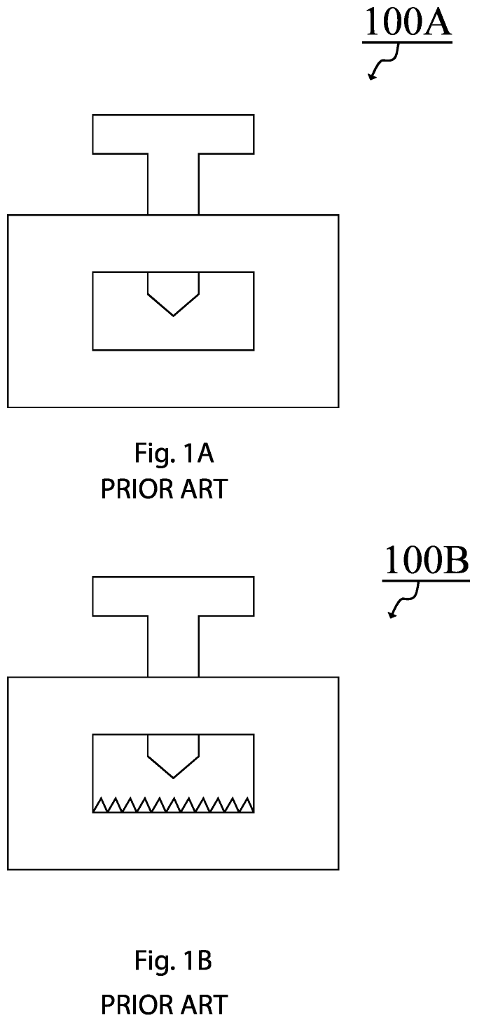

### DETAILED DESCRIPTION OF EXEMPLARY EMBODIMENTS

The present invention will now be described in detail with reference to the drawings, which are provided as illustrative examples of the invention to enable those skilled in the art to practice the invention. Notably, the figures and examples below are not meant to limit the scope of the present invention to a single embodiment, but other embodiments are possible by way of interchange of some or all the described or illustrated elements.

Moreover, where certain elements of the present invention can be partially or fully implemented using known components, only those portions of such known components that are necessary for an understanding of the present invention will be described, and detailed descriptions of other portions of such known components will be omitted so as not to obscure the invention. As used herein, the singular form of “a”, “an”, and “the” include plural references unless the context clearly dictates otherwise. As used herein, the statement that two or more parts or components are “coupled” or “engaged” shall mean that the parts are joined or operate together either directly or indirectly (i.e., through one or more intermediate parts or components, so long as a link occurs).

In the exemplary embodiments described herein, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

As used herein, “directly coupled” means that two elements are directly in contact with each other. As used herein, “fixedly coupled” or “fixed” means that two components are coupled to move as one while maintaining a constant orientation relative to each other. As used herein, “operatively coupled” means that two elements are coupled in such a way that the two elements function together. It is to be understood that two elements “operatively coupled” does not require a direct connection or a permanent connection between them.

As used herein, the word “unitary” means a component is created as a single piece or unit. That is, a component that includes pieces that are created separately and then coupled together as a unit is not a “unitary” component or body. As employed herein, the statement that two or more parts or components “engage” one another shall mean that the parts exert a force against one another either directly or through one or more intermediate parts or components. As employed herein, the term “number” shall mean one or an integer greater than one (i.e., a plurality). As employed herein, the term “substantially” shall mean that the difference is negligible. Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

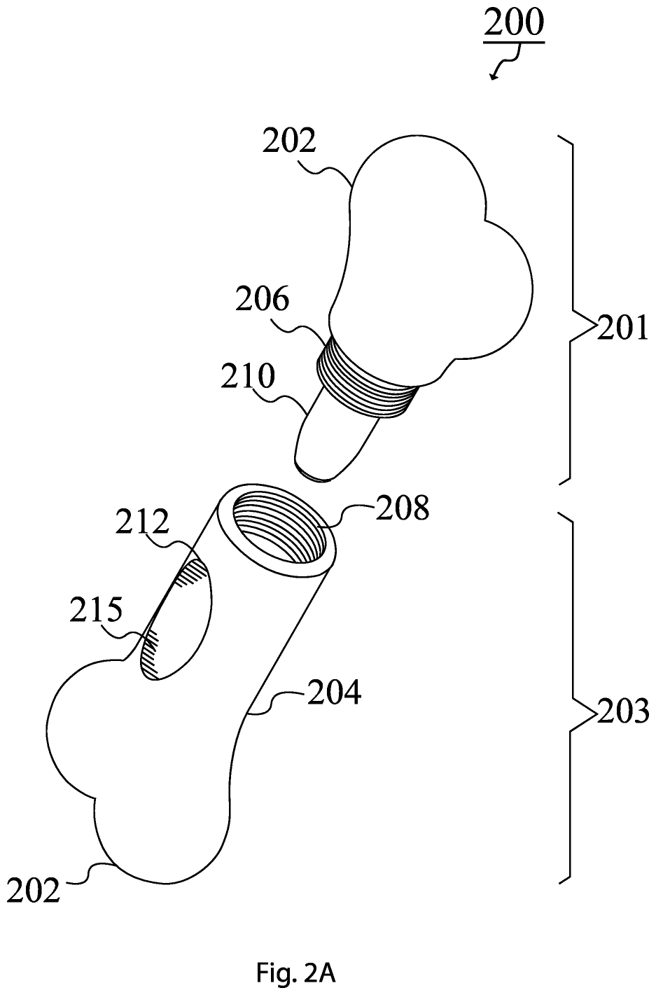

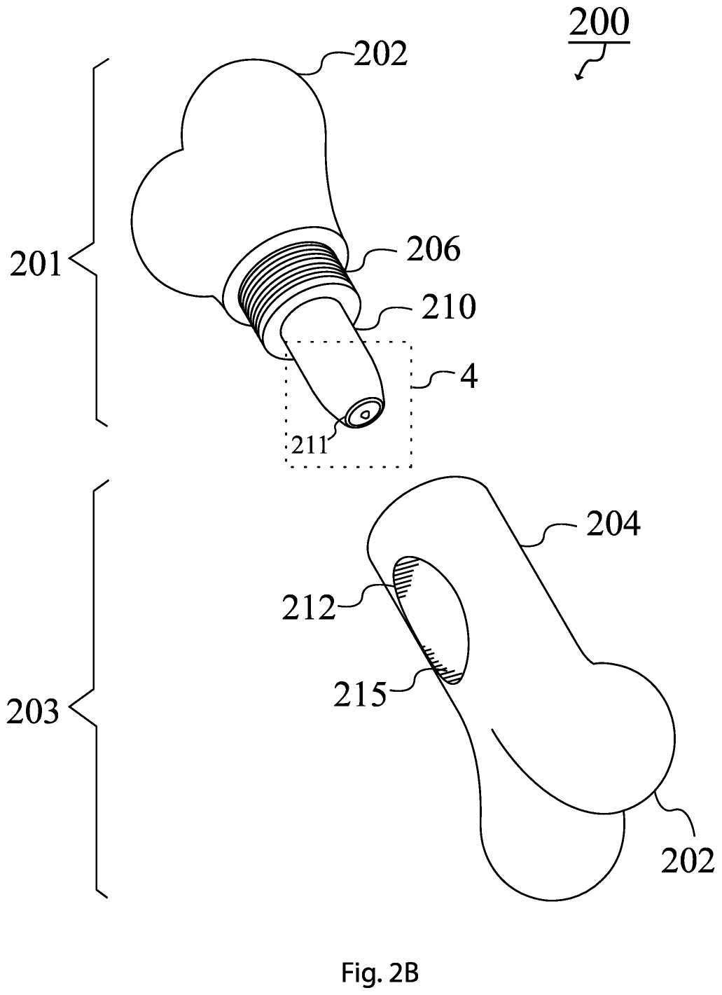

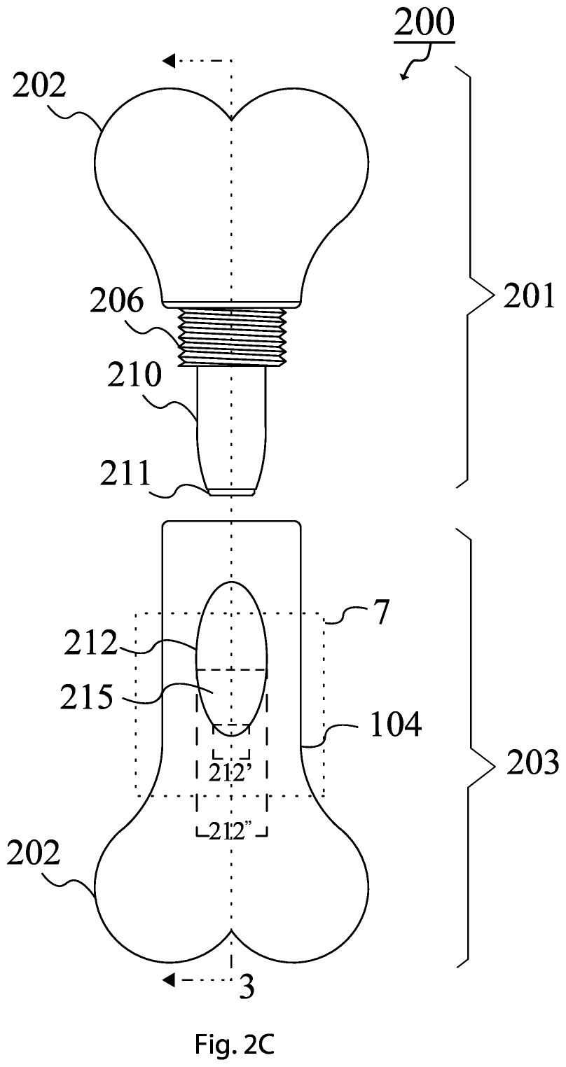

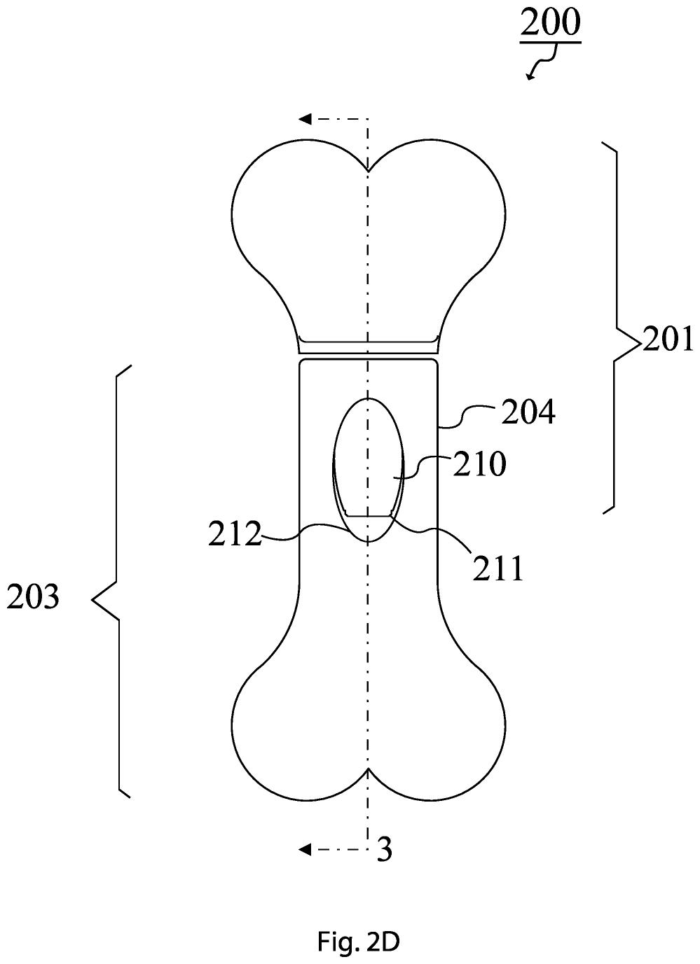

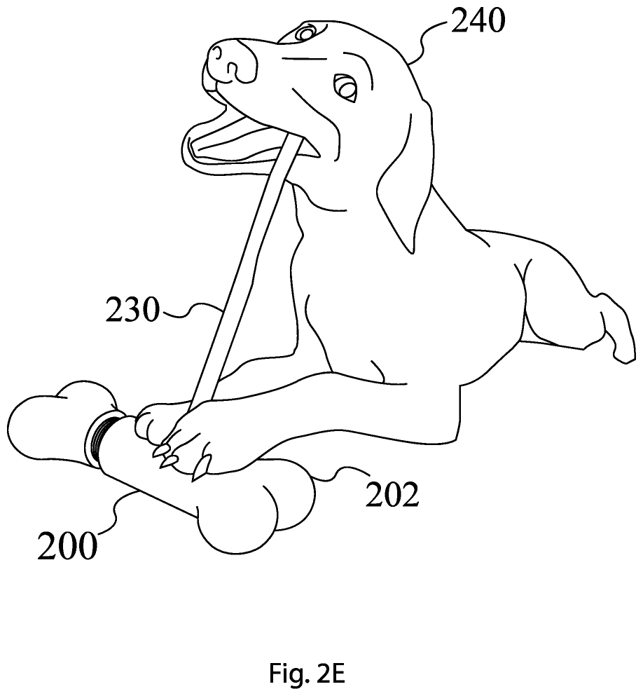

One or more embodiments described herein pertain to an apparatus for securely holding a pet treat, the apparatus being designed for safe and sanitary use, while also presenting an engaging, entertaining platform for pets and pet owners. Moreover, the embodiments described herein are configured for securely holding pet treats in a manner that significantly mitigates the risk of injury to pets. For example, many types of pet treats (e.g., pizzle stick 230 shown in FIG. 2E) become a choking hazard as the treat is reduced to a smaller end portion when consumed by a pet. These smaller end portions create a potential blockage when swallowed whole by a pet (e.g., pet 240 shown in FIG. 2E). In order to prevent choking, the embodiments described herein provide a mechanism for securely holding pet treats while also providing an attractive, hygienic platform that may be enjoyed by both pets and pet owners, thereby increasing user friendliness when compared to the prior art (e.g., holder 100).

Referring now to FIGS. 2A-2E, FIGS. 2A-2E depict pet treat holder apparatus 200 in accordance with some embodiments. As shown in FIG. 2A, in some embodiments, apparatus 200 includes engagement portion 201 and a housing portion 203. In some embodiments, portions 201, 203 are unitary structures. In other embodiments, portions 201, 203 may comprise multiple components that are operatively coupled.

As shown in FIGS. 2A-2B, engagement portion 201 includes handle 202, coupling means 206, and shaft 210. Housing portion 203 includes handle 202, housing body 204, coupling means 208, opening 212, and tapered surface 215. In some embodiments, apparatus 200 is constructed utilizing food-safe, durable plastics, which are non-toxic and safe for contact by pets. In some embodiments, handles 202 are solid filled with a homogenous nylon-based material, while in other embodiments handles 202 are heterogenous and may comprise various layers of nylon-based material and/or other food safe plastics or material, as described below.

For example, in some embodiments, apparatus 200 may be constructed utilizing an injection-molded nylon polymer, which is known for being highly durable, non-toxic and food-safe. In other embodiments, apparatus 200 is constructed utilizing one or more of: PET (Polyethylene Terephthalate), HDPE (High-Density Polyethylene), PVC (Polyvinyl Chloride), uPVC (unplasticized Polyvinyl Chloride), LDPE (Low-Density Polyethylene), PP (Polypropylene), PS (Polystyrene), and/or Polycarbonate. In some embodiments, apparatus 200 is constructed utilizing ceramic components such as stoneware or porcelain. In yet other embodiments, apparatus 200 may be constructed utilizing one or more of: glass, brick, silicon, carbide and/or wooden materials (e.g., teak, mahogany, maple, and the like), alone or in combination. Various components of apparatus 200 (e.g., 202, 204, 206, 210) may be solid while in some embodiments, various components may be hollow and/or partially hollow (e.g., 202, 204, 206, 210).

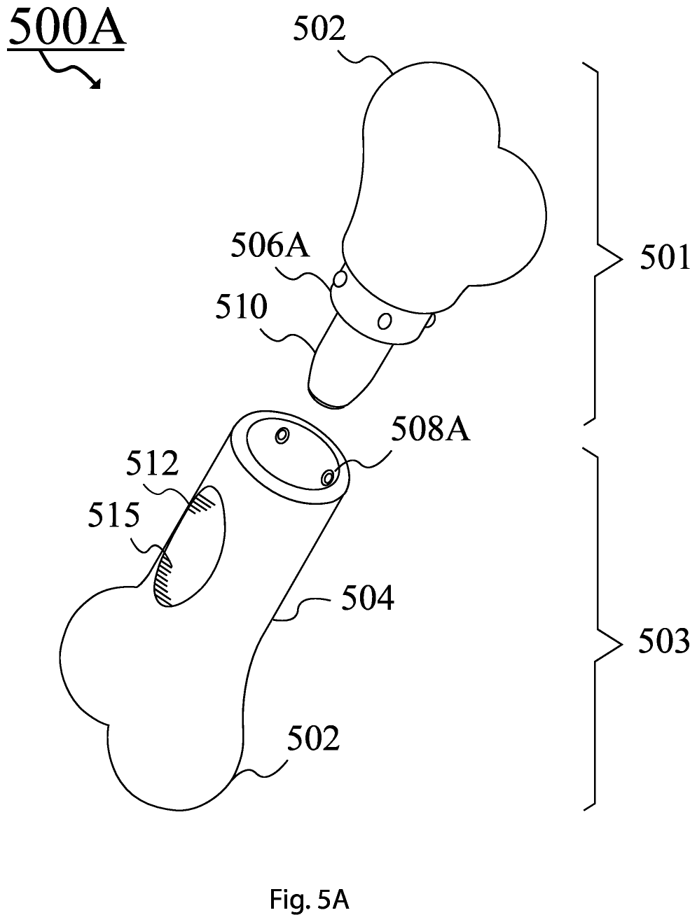

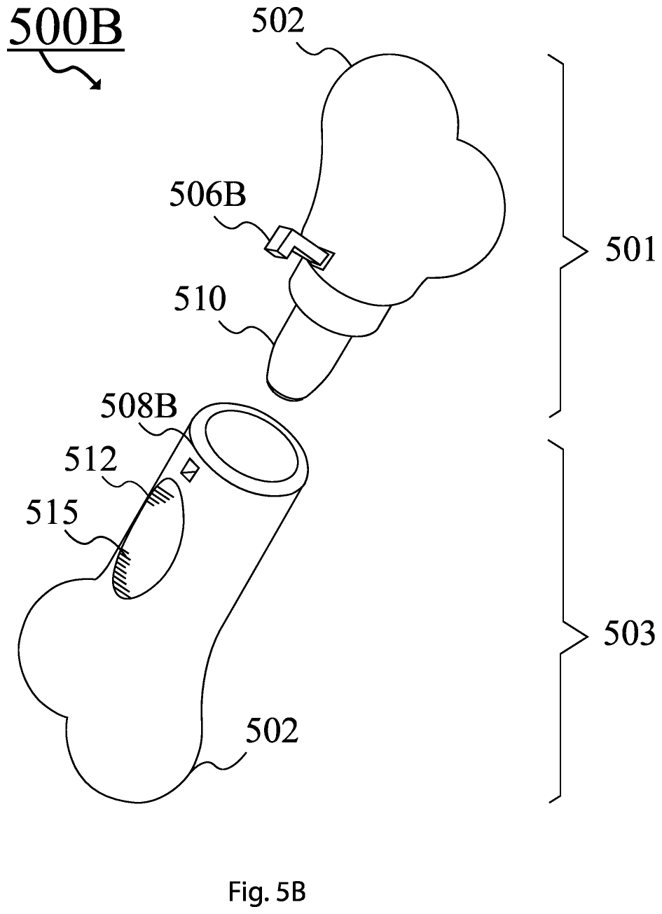

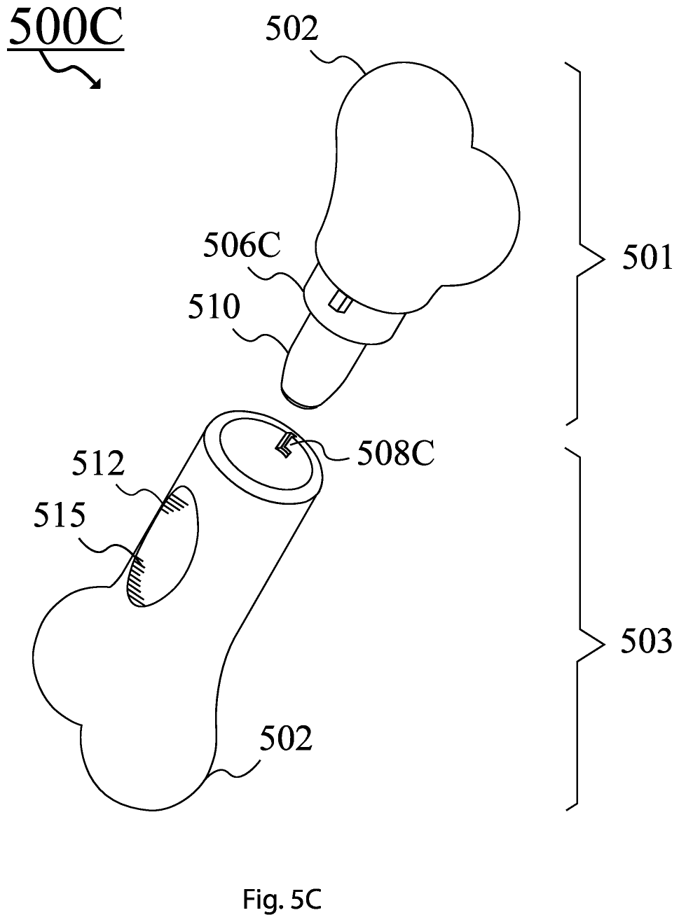

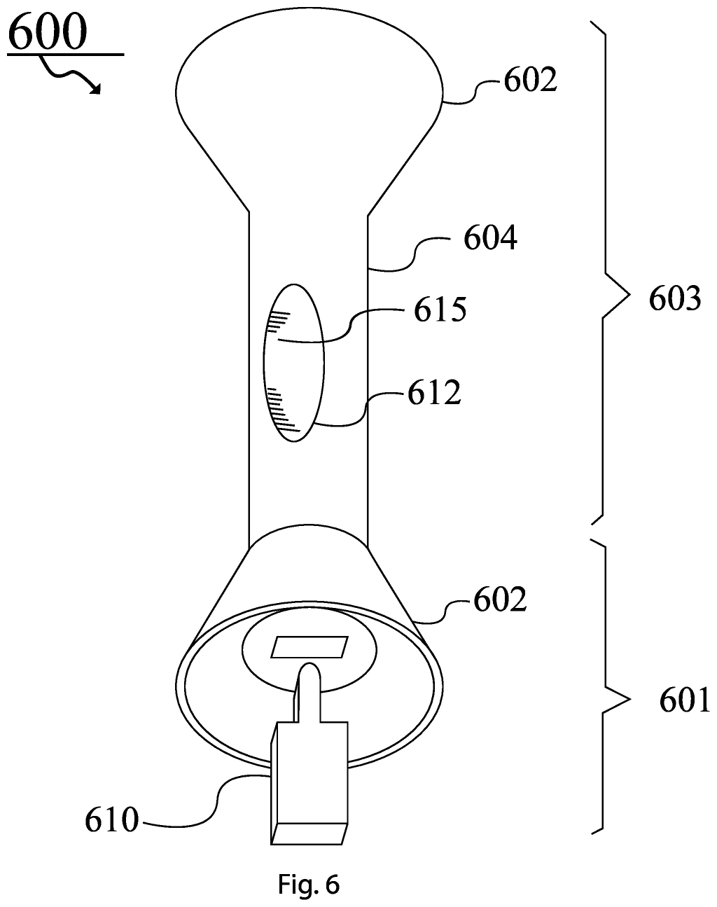

In some embodiments, as shown in FIG. 2A, coupling means 206, 208 may include a male/female threaded coupling 206, 208 which rotatably engage portions 201, 203 of apparatus 200. In other embodiments, coupling means 206, 208 may comprise a latch, a switch, pins and holes, and/or other types of engaging mechanisms, which is discussed in further detail below (e.g., FIGS. 5-6).

As shown in FIGS. 2C-2E, in some embodiments, apparatus 200 includes retaining facet 211 and opening 212 having width 212″ being greater than width 212′. Widths 212′, 212″ facilitate formation of tapered surface 215. Retaining facet 211 engages pet treat 230 when portions 201, 203 are operatively coupled. As shown in FIG. 2D, when operatively coupled, engagement portion 201, shaft 210, housing portion 203 and opening 212 are axially aligned and substantially centered on line 3 of FIG. 2D. In this manner, portions 201, 203 are axially coupled along line 3. When engagement portion 201 and housing portion 203 are operatively coupled, this provides for shaft 210 and retaining facet 211 to exert a force on pet treat 230 placed substantially within opening 212. Tapered surface 215 engages pet treat 230 counter to the engagement of components 210, 211 thereby compressing treat 230 and securely holding pet treat 230 for consumption by pet 240.

For example, subsequent to actuating coupling means 206, 208 (e.g., via rotational actuation of handles 202) pet treat 230 may be positioned substantially and partially inside housing portion 203 via opening 212 (e.g., as shown in FIG. 2E). Once actuated via coupling means 206, 208, portions 201, 203 securely engage pet treat 230. In this manner pet 240 may consume treat 230 without the risk of injury when treat 230 is nearly entirely consumed and may present a choking hazard.

Securely engaging a pet treat means the treat will not become dislodged when consumed by a pet. By not becoming dislodged, the end portion of treat 230 will not be accessible by pet 240, thereby preventing the risk of choking on the small end portion of pet treat 230. Moreover, tapered surface 215, via opening 212 and coupling means 206, 208, provides for easy access for cleaning and disinfecting apparatus 200.

Referring to FIG. 2D-2E, implemented for securely retain treat 230, housing 204 includes opening 212 and tapered surface 215. Tapered surface 215 includes width 212′ that is less than width 212.″ For example, in some embodiments, width 212′ is toward a distal end of opening 212, or toward a substantially distal end of opening 212. In some embodiments, width 212″ is toward a center point of opening 212, or toward a substantially center point of opening 212. The differences in widths 212′ and 212″ allows for shaft 210 to securely retain treat 230 between tapered surface 215 and retaining facet 211. Utilizing tapered surface 215 for securely retaining a pet treat allows for easy cleaning via opening 212 and/or coupling 208.

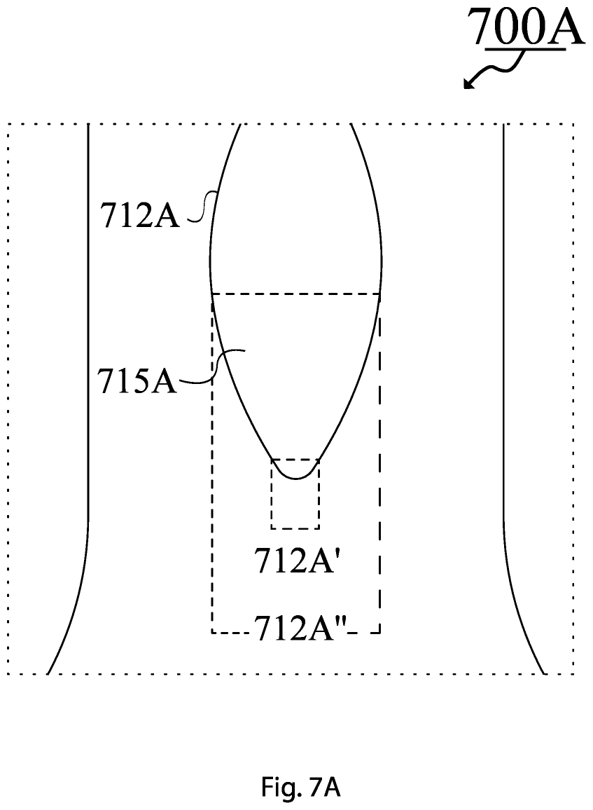

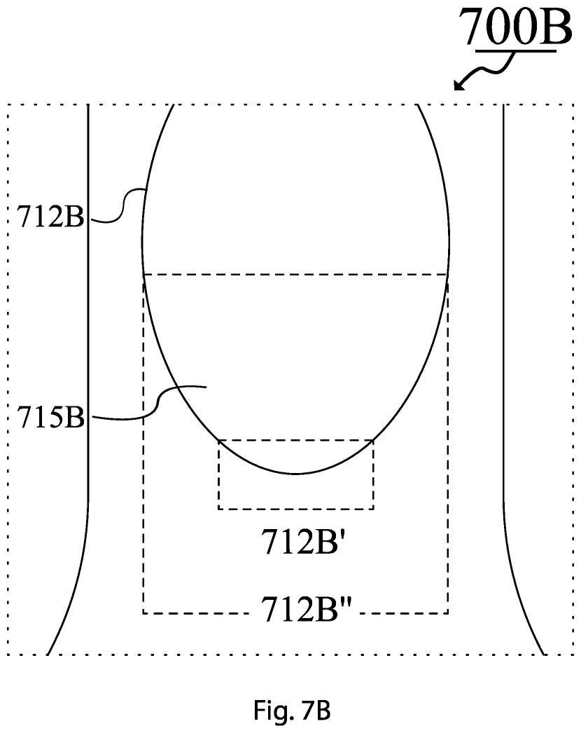

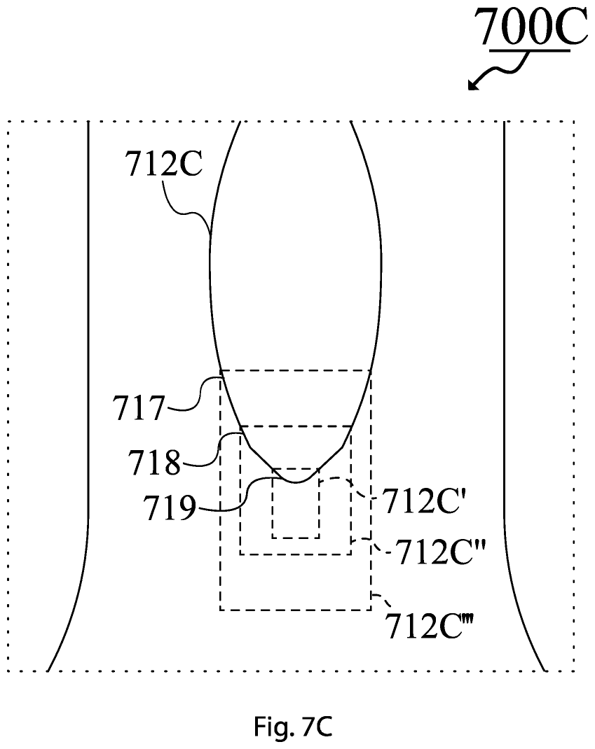

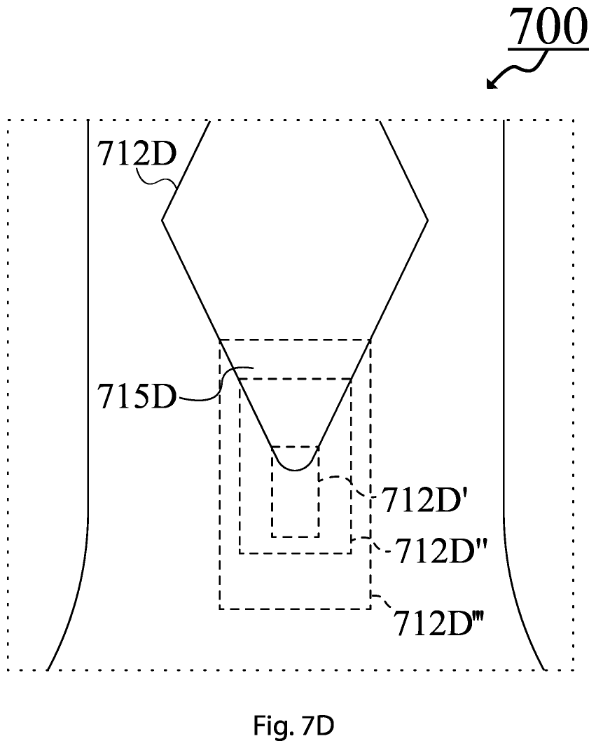

In some embodiments, because tapered surface 215 is a smooth, featureless surface, this prevents small food particles from becoming lodged inside housing 204. Moreover, because tapered surface 215 is easily accessible via opening 212, cleaning of any residue left from treat 230 is fast and user friendly. In some embodiments, the construction of opening 212 may include varied shapes and structures for providing a variety of tapered surfaces corresponding to different sizes and shapes of treats, which is discussed in detail in FIGS. 7A-7D below.

As shown in FIGS. 2A-2E, apparatus 200 includes handles 202 on at least one end of apparatus 200. Handles 202 and may be utilized for holding apparatus 200 while securing pet treat 230 by actuating engagement means 206, 208. Handles 202 may be positioned on substantially opposite sides of apparatus 200, for example, as shown in FIG. 2E. As shown, pet 240 may also utilize handles 202 for holding apparatus 200 while consuming pet treat 230. In some embodiments, handles 202 corresponds to a shape of a bone. In other embodiments, handles 202 correspond to turnkey handles, recessed handles, and/or polygon structures, which is discussed in further detail below.

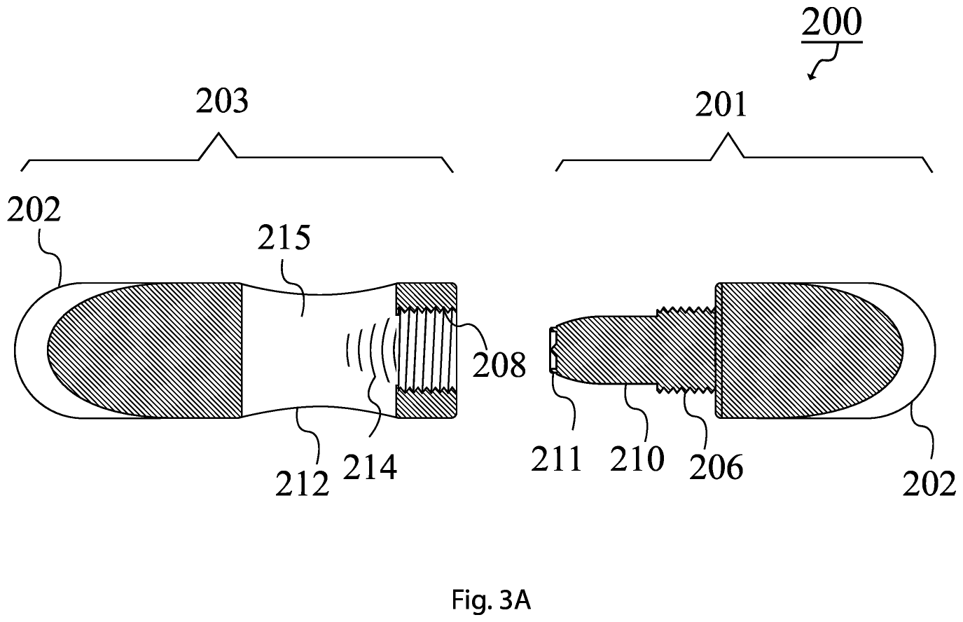

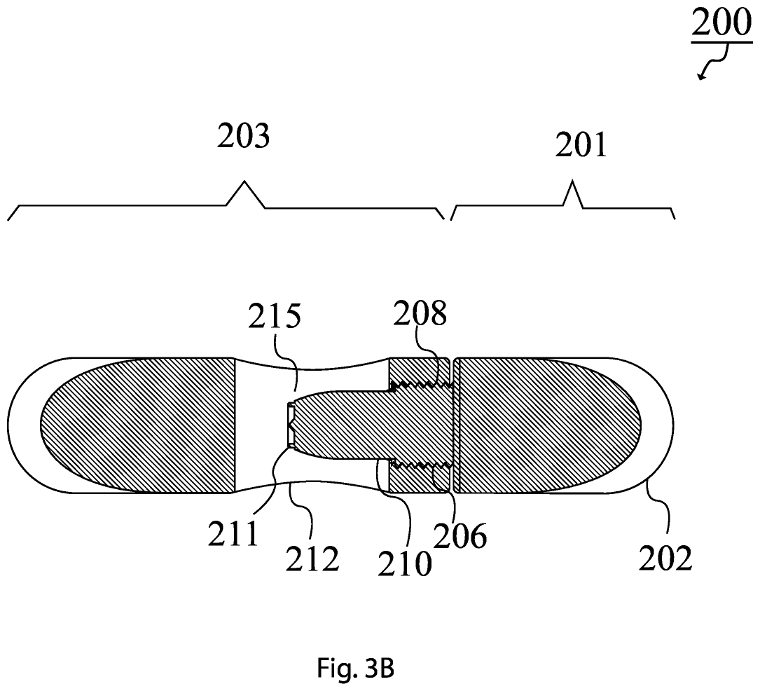

Referring now to FIGS. 3A-3B in conjunction with FIGS. 2A-2E, FIGS. 3A-3B illustrate cutout views of the interior of apparatus 200 based on cutout line 3 of FIG. 2C. FIG. 3A shows portions 201, 203 set apart from one another. FIG. 3B shows portions 201, 203 operatively coupled for securely holding a pet treat. Housing portion 203 includes shaft recess 214. Shaft recess 214 includes a structure that substantially corresponds to a structure of shaft 210.

For example, in some embodiments, shaft recess 214 is configured to compliment and accommodate the structure of shaft 210. The complimentary structure of recess 214 and shaft 210 increases the retention ability of apparatus 200 when securely retaining a pet treat. Moreover, shaft recess 214 provides a fit that is substantially free from pinch points when coupling portions 201, 203 and placing a treat via opening 212.

For example, when portions 201, 203 are engaged via coupling 208, 206, shaft recess 214 substantially mitigates movement of shaft 210 inside housing body 204 by reducing the surface space between components (e.g., 210, 204). In this manner shaft 210 is further secured within housing body 204. Shaft recess 214 therefore further prevents food particles from clogging and smearing inside apparatus 200. In this manner, apparatus 200 provides a platform that is exceedingly more robust when compared to prior art pet treat holders (e.g., 100).

In some embodiments, shaft 210 and housing portion 204, are configured for securely retaining a pet treat by utilizing retaining facet 211. As shown in FIG. 2B, in some embodiments, engagement portion 201 includes retaining facet 211 positioned on a distal end of shaft 210. Secure retention of a pet treat is facilitated by generating a compression and friction force that pins a pet treat (e.g., 230) against tapered surface 215 and retaining facet 211.

For example, in operation, a user must first place pet treat 230 at least partially inside housing 204 via opening 212. Next the user must operatively couple portion 201, 203 via coupling means 206, 208. In this manner, surface 215 and retaining facet 211 engage pet treat 230, creating a squeezing compression force similar to vice clamp. The compression force generated by surface 215 and friction force generated by retaining facet 211 allows for securely holding pet treat 230 without risk of disengagement from apparatus 200. The compression and friction force combine to counter any pulling and pushing forces induced on pet treat 230 during consumption of treat 230 by pet 240. This reduces, for example, that potential for staining or treat misplacement and/or dislodgment during consumption of treat 230, thereby increasing the user friendliness of apparatus 200.

In some embodiments, the compression and friction forces generated by components 210, 211, 215 may be adjusted via coupling 206, 208. For example, in some embodiments, coupling means 206, 208 include a female/male threaded coupling that rotatably engages with one another. By adjusting the degree or amount of rotation, the compression and friction forces applied to pet treat 230 may be increased or decreased. In this manner, various types of pet treats with varying hardness and thickness may all be utilized in apparatus 200. In some embodiments, tapered surface 215 may include more a varied degree of taper (e.g., one or more different slopes and/or curves), which is discussed in further detail below (e.g., FIGS. 7A-7C).

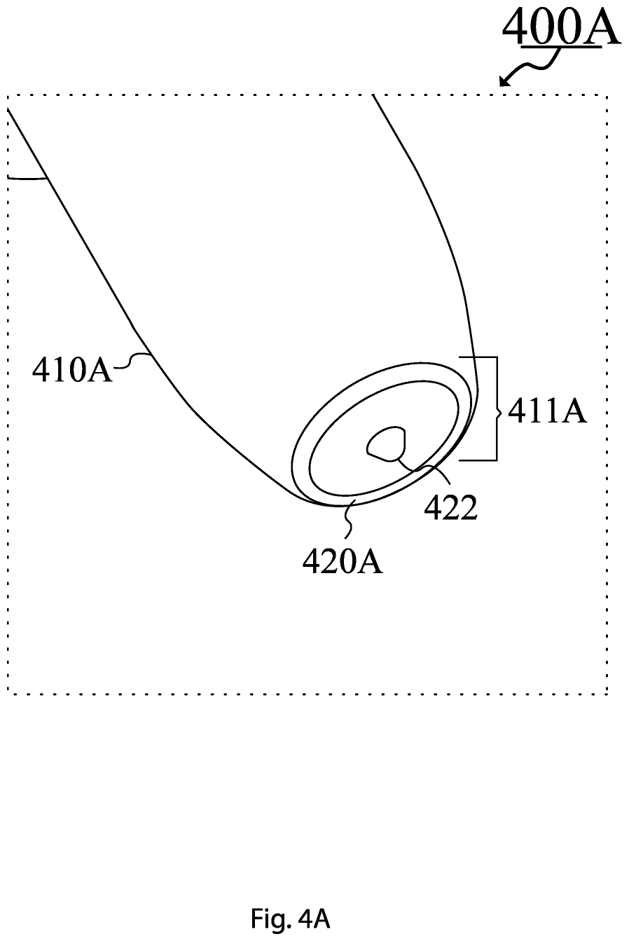

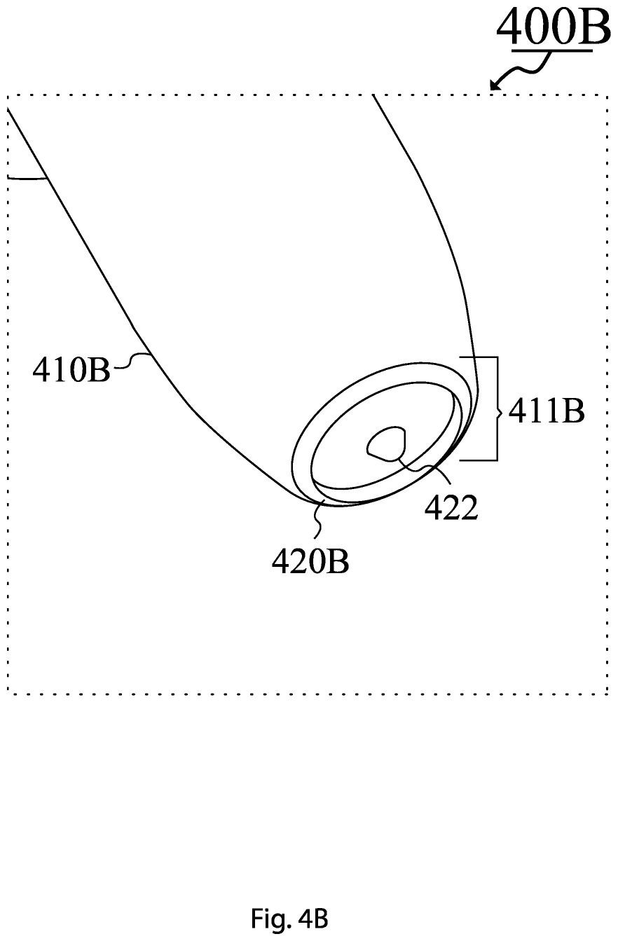

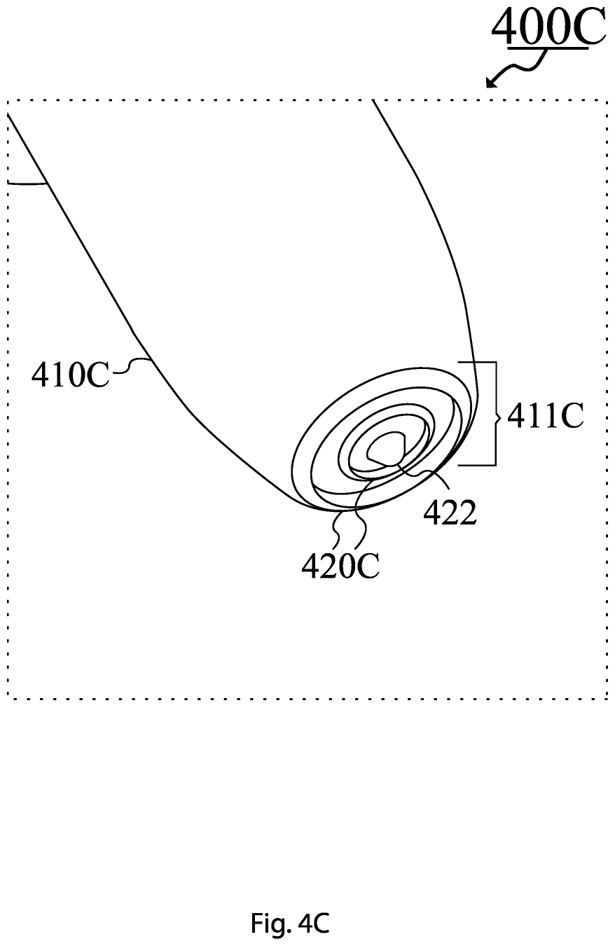

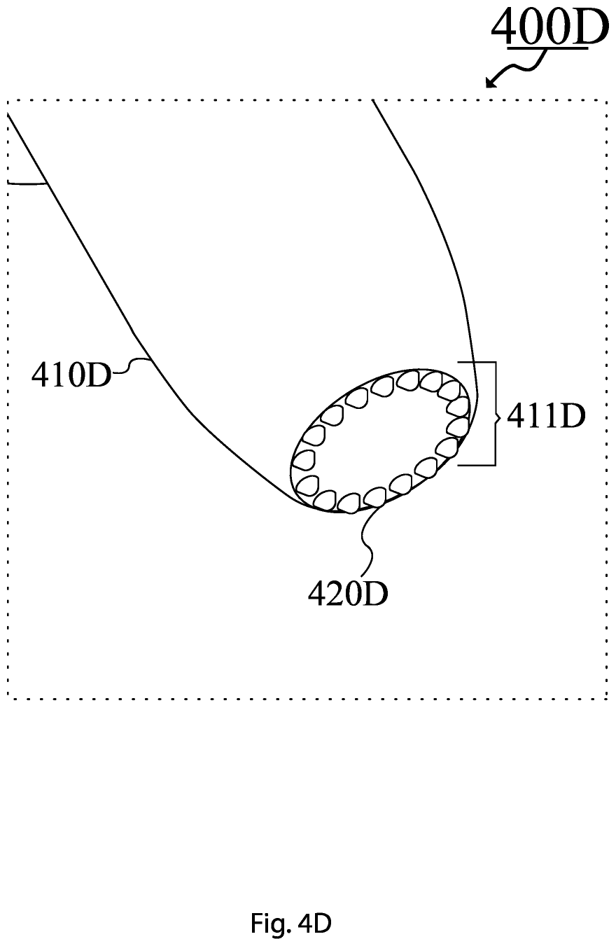

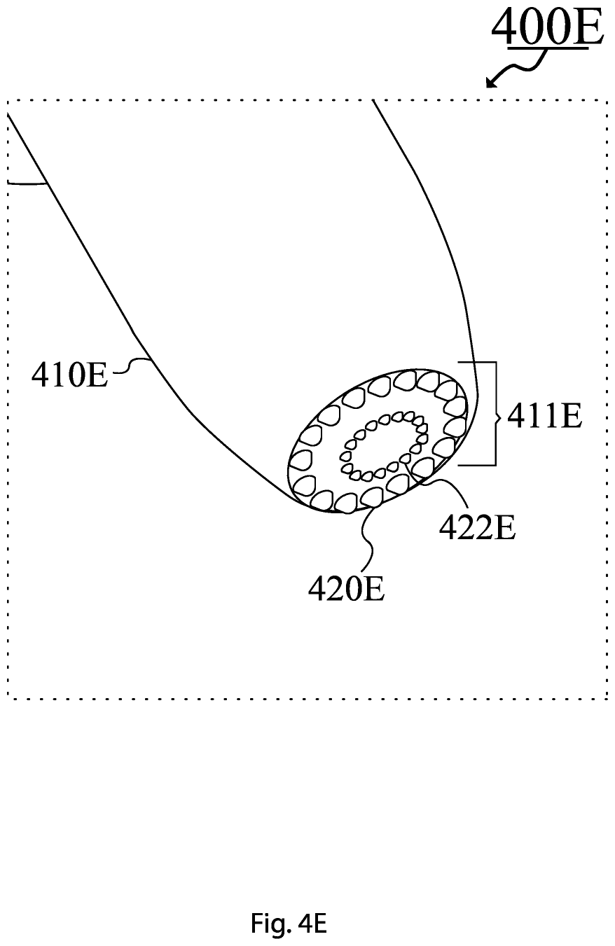

Referring now to FIGS. 4A-4E in conjunction with FIGS. 2A-2E, FIGS. 4A-4E depict apparatus 400A-400E, respectively, which are embodiments of apparatus 200 in which similarly labeled numbers correspond to similar parts having similar functionality. In some embodiments, apparatus 400A includes shaft 410A and retaining facet 411A. Retaining facet 411A may include either or both of a rounded ridge 420A and/or a central pin 422. Rounded ridge 420A and central pin 422 provide a means for increasing the friction force facilitated by the compression force of components discussed above (e.g., 215, 211, 210). For example, ridge 420A and pin 422, in conjunction with tapered surface 215/shaft 210, provide a friction force against pet treat 230 that counters the pulling and pushing force applied from pet 240 during consumption of pet treat 230.

In some embodiments, shaft 410 includes tapered ridge 420B and/or central pin 422. In yet other embodiments, shaft 410C, including retaining facet 411C, has more than one concentric tapered ridge. For example, having two tapered ridges 420C and central pin 422, as shown in FIG. 4C. As shown, retaining facet 411, 211 includes central pin 422, 222. Central pin 422, 222 may include a substantially central pin. In some embodiments, pin 422, 222 may be placed off-center.

In some embodiments, there may be multiple pins (e.g., 420E). For example, two or three pins 422 may be positioned in a symmetrical or asymmetrical fashion. In some embodiments, there are no ridges utilized in retaining facet 211, 411. Rather, concentric pins 420E, 422E may be fashioned on an outside perimeter of retaining facet 411E, as shown in FIG. 4E. In some embodiments, retaining facet 411 includes more than two concentric tapered ridges (e.g., 3, 4, 5 or more concentric ridges).

In some embodiments, retaining facet 411, 211 may include one or more pins 422 positioned substantially evenly throughout retaining facet 411, 211. In other embodiments, various types of gripping features may be utilized, for example, threaded patterns and/or hash marks, which have been fully contemplated herein. While other gripping features may be utilized without diverting from the scope and spirit of the embodiments disclosed herein, the embodiments discussed herein are especially well suited for providing both a secure gripping means for holding a pet treat in place, while also allowing for easy cleaning of apparatus 200, 400.

Referring now to FIGS. 5A-5C, in some embodiments, pet treat holder apparatus includes apparatus 500. Apparatus 500 is an embodiment of apparatus 200, 400 in which similarly labeled numbers correspond to similar parts having similar functionality. As shown in FIGS. 5A-5C, apparatus 500 includes engagement portion 501 and housing portion 503. Coupling 506, 508 functions to removably engage portions 501, 503 with one another.

As shown in FIG. 5A, in some embodiments, coupling 506A, 508A correspond to a locking ball pin joint. For example, engagement portion 501 removably engages with housing portion 503 via coupling 506A, 508A when inserting shaft 510 into housing body 504. When portions 501, 503 are coupled via coupling 506, 508, this causes shaft 510 to secure a pet treat against tapered surface 515 in a manner that substantially secures a pet treat in place without risk of becoming dislodged. In this manner, a pet may consume the treat without any suffocation risk from the end piece of the pet treat, which may become a choking hazard for pets.

As shown in FIG. 5B, in some embodiments, coupling 506B, 508B includes a latching mechanism. In yet other embodiments, coupling 506C, 508C include a notch and recess type mechanism that rotatabley locks a notch into a corresponding recess, shown in FIG. 5C. These and other coupling mechanisms may be used without diverting from the scope and spirit of the embodiments described herein. A person having ordinary skill in the art would understand other available coupling means may be utilized without diverting from the scope and spirit of the embodiments described herein.

Referring now to FIG. 6, FIG. 6 depicts a pet treat holder apparatus 600. Pet treat holder apparatus 600 is an embodiment of pet treat holder apparatus 200, 400, 500, in which similarly labeled numbers correspond to similar parts having similar functionality. As shown in FIG. 6, apparatus 600 includes engagement portion 601 and housing portion 603. Housing portion 603 includes housing body 604 coupled to handle 602. Handle 602 is positioned at a distal end of engagement portion 603. Housing portion 603 includes opening 612 and tapered surface 615.

Engagement portion 601 includes shaft 610, which is configured to engage a pet treat at least partially or completely within housing body 604, via opening 612. When engaged as shown in FIG. 6, shaft 610 and tapered surface 615 are configured for securely holding a pet treat placed inside opening 612 for consumption by a pet. Handles 602 may also provide a gripping means during consumption of a secured pet treat. Holding means is defined as a portion of the apparatus that may be used for holding down the apparatus during consumption of the pet treat, for example, as shown in FIG. 2E.

As shown, handles 602 are positioned on substantially distal ends of portions 601, 603. In some embodiments, handles 602 substantially correspond to a conical shape as shown in FIG. 6. In some embodiments, handles 602 correspond to polygon or non-polygon structures. In some embodiments, handles 602 correspond to a substantially cylindrical, triangular, rectangular, and/or trapezoidal shape and/or fanciful designs such as bones, tails, and/or faces, which a person having ordinary skill would readily recognize how to implement and manufacture.

Referring now to FIGS. 7A-7D, FIGS. 7A-7D depict apparatus 700. Apparatus 700 is an embodiment of apparatus 200, 400, 500, 600 in which similarly labeled numbers correspond to similar parts having similar functionality. In some embodiments, apparatus 700 is configured for complimenting various size and shapes of pet treats. This is accomplished by having varied widths 712′,712″ (e.g., 712A-712D), varied shapes of opening 712 (e.g., 712A-712D), and/or multiple tapered surfaces 715 (e.g., 715A-715D) as shown in FIGS. 7A-7D.

For example, in some embodiments, opening 712A includes widths 712′ and 712″ corresponding to tapered surface 715A. Opening 712A may correspond to a substantially teardrop type shape having a degree of taper that differs from opening 212 and tapered surface 215, for example. In some embodiments, opening 712B may include includes widths 712B′ and 712B″ corresponding to tapered surface 715B. Opening 712B may correspond to a substantially wide ellipse shape when compared to opening 212, 712A, for example.

In some embodiments, opening 712 may include one or more than one degree of taper via multiple tapered surfaces. As shown in FIG. 7C, in some embodiments, opening 712 C includes widths 712C′, 712C″, and 712′″. Widths 712C′, 712C″, 712C′″ form multiple tapered surfaces 717, 718, 719 each having a varied degree of taper. In some embodiments, opening 712D corresponds to a substantially rhomboidal shape wherein opening 712D includes tapered surface 715D with one degree of taper via widths 712D′, 712D″, 712D′″. In this manner, apparatus 700 may accommodate varied shapes and sizes of pet treats via varied degree of taper for engagement of pet treats, while simultaneously providing easily accessible components for maintaining a safe and hygienic platform for consumption of pet treats, thereby increasing the user enjoyment for both pets and pet owners.

Dimensions shown in the figures are for exemplary purposes only and are not meant to be limiting, unless specifically claimed. In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

Although the description provided above provides detail for the purpose of illustration based on what is currently considered to be the most practical embodiments, it is to be understood that such detail is solely for that purpose and that the disclosure is not limited to the expressly disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A pet treat holder apparatus for securely retaining a pet treat, the apparatus comprising:
a housing portion, the housing portion including a first coupling means and an opening, the opening including a first width being less than a second width thereby forming a tapered surface; and
a shaft portion including a retaining facet and a second coupling means, the shaft portion and the housing portion being axially coupled.

2. The apparatus of claim 1, wherein the shaft portion and the housing portion are configured to securely retain a pet treat between the tapered surface of the housing portion and the retaining facet of the shaft portion.

3. The apparatus of claim 1, the apparatus further comprising at least one handle on at least one end of the apparatus.

4. The apparatus of claim 3, wherein the at least one handle corresponds to a shape of a bone, a turnkey handle, a recessed handle, or a polygon structure.

5. The apparatus of claim 1, wherein the retaining facet of the shaft portion includes a ridge.

6. The apparatus of claim 1, wherein the retaining facet of the shaft portion includes a pin.

7. The apparatus of claim 1, wherein the body portion is configured to removably engage the housing portion via at least one of: a threaded coupling, a plurality of fasteners, a plurality of latches, or a locking mechanism.

8. The apparatus of claim 1, wherein the first and second coupling means are actuated by a handle, the handle being recessed in the second coupling means or positioned on a distal end of the apparatus.

9. A pet treat holder apparatus, the apparatus comprising:
a body portion having a first distal end handle; and
a housing portion having a second distal end handle,
wherein the body portion and the housing portion are configured to be removably coupled via a threaded male/female coupling, and wherein an actuator for the threaded male/female coupling corresponds to the first distal end handle or the second distal end handle.

10. The apparatus of claim 9, wherein the first distal end handle or the second distal end handle corresponds to a shape of a bone.

11. The apparatus of claim 9, the first distal end handle or the second distal end handle is configured for holding the pet treat holder apparatus.

12. The apparatus of claim 9, wherein the at least one handle corresponds to a shape of a turnkey handle, a recessed handle, or a polygon structure.

13. The apparatus of claim 9, wherein the at least one handle corresponds to a conical shape.

14. The apparatus of claim 9, the body portion further comprising a shaft portion having a retaining facet.

15. The apparatus of claim 10, the retaining facet including a pin or at least one ridge.

16. The apparatus of claim 9, wherein the body portion is configured to removably engage the housing portion via at least one of: a threaded coupling, a plurality of fasteners, a plurality of latches, or a locking mechanism.

17. The apparatus of claim 9, wherein the shaft portion and the housing portion are configured to securely retain a pet treat between a tapered surface of the housing portion and a retaining facet of the shaft portion.

18. A pet treat holder apparatus, the apparatus comprising:
a body portion having a first distal end handle; and
a housing portion having a second distal end handle,
wherein the body portion and the housing portion are configured to be removably coupled via a turnkey handle coupling, the turnkey handle coupling being recessed into the first distal end handle or the second distal end handle

19. The apparatus of claim 18, wherein the first distal end handle or the second distal end handle corresponds to a shape of a cone.

20. The apparatus of claim 18, wherein the body portion includes a retaining facet and a shaft portion, and wherein the body portion and the housing portion are configured to securely retain a pet treat between a tapered surface of the housing portion and a retaining facet of the shaft portion.
